(19) United States
(12) Patent Application Publication
(10) Pub. No.: US 2016/0123357 A1
(43) Pub. Date: May 5, 2016

(54) UNIVERSAL VELOCITY STACK AND METHOD FOR CREATING LAMINAR AIR FLOW

(71) Applicant: PHASE 2 MOTORTREND INC., WALNUT, CA (US)

(72) Inventor: WAYNE OUN, WALNUT, CA (US)

(21) Appl. No.: 14/818,208

(22) Filed: Aug. 4, 2015

Related U.S. Application Data
(60) Provisional application No. 62/073,913, filed on Oct. 31, 2014.

(51) Int. Cl. F15D 1/06; B23P 15/00

(52) U.S. Cl. CPC F15D 1/06; B23P 15/00

(57) ABSTRACT

A universal velocity stack detachably connects to various types of throttle bodies, and is shaped and dimensioned to enable a laminar air flow through the throttle body, both at low velocities, and even at high velocities, where air turbulence ordinarily occurs. In this manner, fuel economy and engine performance may be enhanced as a smoother, larger density of air enters an intake manifold. The universal velocity stack is adapted to be coupled to the throttle body air inlet. The universal velocity stack is configured to detachably connect with eclectic types and sizes of throttle body air inlets for both fuel injection, and carburetor types of throttle bodies. The universal velocity stack forms a substantially trumpet shape. A cylindrical tube portion integrates into a gradually widening mouth portion. The tube portion and the mouth portion form unique surfaces and curvatures that enable formation of the laminar air flow.

### CROSS-REFERENCE TO RELATED APPLICATIONS

This Non-Provisional patent application claims priority from the Provisional Patent Application No. 62/073,913.

### FIELD OF THE INVENTION

The present invention relates generally to a velocity stack and method for creating laminar air flow. More so, a universal velocity stack detachably connects to various types of throttle bodies, and is shaped and dimensioned to enable the formation of a laminar air flow both at both low and high, where air turbulence ordinarily occurs.

### BACKGROUND

Typically, air intake manifolds comprise a manifold body formed with a plenum having an inlet connected to an air or throttle valve. A number of air passages or runners are formed in the manifold body having an inlet at the plenum interior and an outlet connected to one of the cylinders of the engine. A flow of air is directed into the plenum interior and then distributed into the several runners for transmission to the cylinders of the engine where it is intermixed with fuel supplied by fuel injectors. In many designs, a mixture of fuel and air, or air only, is directed into the interior of the plenum through a throttle valve mounted to the manifold body. The throttle valve controls the volume of air, or air-fuel mixture, entering the plenum for distribution to each of the runners.

Increasing power and improving fuel efficiency of internal combustion engines is particularly desirable across the population of automobile drivers. One method of increasing power and improving fuel efficiency is to increase the volume of dense air flowing into the combustion chamber of a vehicle's engine. Generally, the greater the efficiency level of the intake system, the greater horsepower output there will be. Often, internal combustion engines develop horsepower directly proportional to air flow through a plurality of tubular air intake devices, or velocity stacks, which are disposed in an air box portion of the engine, where the air box portion is secured to and on top of a carburetor or throttle body which controls air flow into the cylinders of an engine.

One of the greatest sources of inefficiency in this style of airflow generating device is turbulence. As airflow enters through the air intake aperture, turbulence forms as the air deflects at less than ideal angles off the different flat and oblique surfaces of the velocity stack, intake tube, air filter, air box, and inner surface of the intake manifold. What is needed is a manner of making the airflow more laminar and less turbulent, such that intake air flow is made to efficiently flow through the throttle body, both at low velocities, and at high velocities, where air turbulence ordinarily occurs.

Other proposals have involved tempering intake airflow into an intake manifold for feeding the engine a desired air/fuel mixture. Thus, an unaddressed need exists in the industry to address the aforementioned deficiencies and inadequacies. Even though the above cited methods for tempering intake airflow with a velocity stack meets some of the needs of the market, a universal velocity stack and method that creates efficient airflow through an air intake by tempering high velocity and low velocity airflow to a more manageable uniform airflow, while also being adaptable to be used with myriad air intake systems including for a numerous combustion related devices is still desired.

### SUMMARY

The present invention is directed to a universal velocity stack and method for creating laminar airflow through an intake manifold. The universal velocity stack is configured to detachably mate with various types of throttle bodies. The universal velocity stack is shaped and dimensioned to enable a laminar air flow to efficiently flow through the throttle body, both at low velocities, and at high velocities, where air turbulence ordinarily occurs. In this manner, fuel economy and engine performance may be enhanced as a smoother, larger density of air enters an intake manifold. Additionally, the universal velocity stack can be used on multiple throttle bodies for different engines.

In some embodiments, the universal velocity stack is configured to provide an improved throttle body air inlet that maximizes the stability and quantity of the air delivered to the intake manifold. The universal velocity stack is adapted to be coupled to the throttle body air inlet. The universal velocity stack is configured to detachably connect with eclectic types and sizes of throttle body air inlets for both fuel injection, and carburetor types of throttle bodies. However, in some embodiments, the velocity stack is generally designed for enhancing air flow in combustion engines, and specifically automobile engines having fuel injection systems.

In one aspect, a velocity stack for enabling laminar air flow at low and high velocities, comprises:
a generally cylindrical tube portion comprising a tube first end and a tube second end, the tube portion defined by a uniform, interior diameter defined by an axis of symmetry; and
a mouth portion comprising a mouth first end and a mouth second end, the mouth first end being contiguous with the tube second end, the mouth portion defined by an interior surface contiguous with the interior diameter of the tube portion, the interior surface of the mouth portion forming a surface of revolution about the axis of symmetry, the surface of revolution defined by a radius of curvature commencing at the mouth second end and increasing at a constant, linear rate towards the mouth first end, whereby air drawn into the mouth portion is induced to flow in a substantially laminar manner.

In another aspect, the mouth portion of the velocity stack has a substantially bell shape.

In another aspect, the tube portion of the velocity stack has a substantially elongated, cylindrical shape.

In yet another aspect, the tube first end is configured to detachably mate with a throttle body air intake.

In yet another aspect, the radius of curvature is a measure of the radius of the mouth portion which best approximates the curve at a point in the interior surface.

In yet another aspect, the velocity stack is fabricated from a metal alloy.

One objective of the present invention is to provide a universal velocity stack which maximizes air flow through a throttle body for digestion by an intake manifold.

Another objective is to provide a universal velocity stack which at least partially inhibits turbulent eddy flow at the input to the throttle body.

Another objective is to provide a universal velocity stack that can detach from a first throttle body and reattach to a second throttle body quickly and with minimal skills or tools.

Another objective is to provide a universal velocity stack which is inexpensive and simple to fabricate.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram view of an exemplary universal velocity stack receiving intake airflow and outputting uniform airflow, in accordance with an embodiment of the present invention;

FIG. 2 illustrates a perspective view of an exemplary universal velocity stack, in accordance with an embodiment of the present invention;

FIG. 3 illustrates an elevated side view of an exemplary universal velocity stack, in accordance with an embodiment of the present invention;

FIG. 4 illustrates a top view of an exemplary universal velocity stack, in accordance with an embodiment of the present invention; and

FIG. 5 illustrates a flowchart diagram of an exemplary method for creating a laminar airflow through an intake manifold, in accordance with an embodiment of the present invention.

Like reference numerals refer to like parts throughout the various views of the drawings.

### DETAILED DESCRIPTION OF THE INVENTION

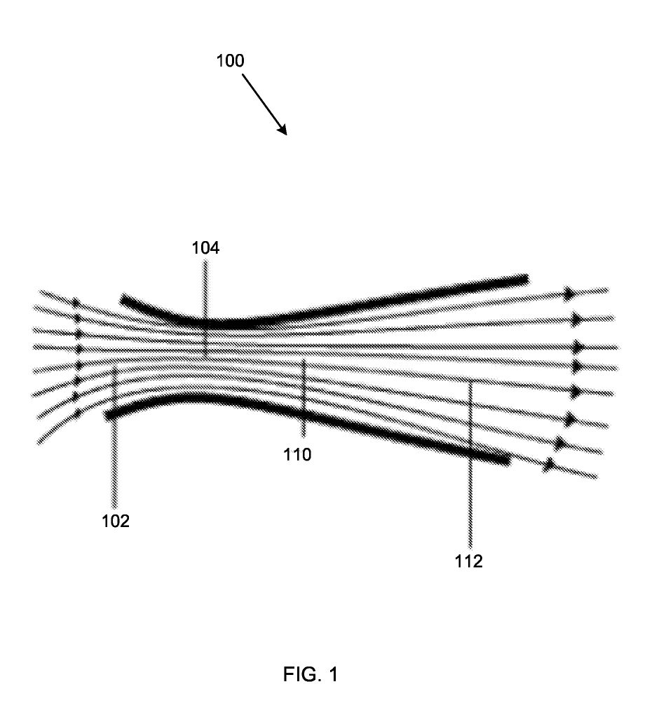

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

In one embodiment of the present invention presented in FIGS. 1-5, a universal velocity stack 100 and method 200 of use helps create efficient airflow through an air intake by tempering high velocity and low velocity airflow to a more manageable uniform airflow. The absence of turbulence creates the uniformity that is desirable for air intakes. The velocity stack 100 is adaptable to be used with myriad air intake systems including for a numerous combustion related devices.

Those skilled in the art, in light of the present teachings, will recognize that the greatest sources of inefficiency during the intake of airflow and the attached devices, is turbulence. Typically, a fan is typically held onto the motor through use of a retaining means such as a nut and bolt. As airflow enters through the air intake aperture, turbulence forms as the air deflects at less than ideal angles off the off the flat surfaces and oblique shapes of the intake components. The universal velocity stack 100 helps streamline the airflow into an airflow-generating device to create more laminar and less turbulent airflow intake.

As illustrated in FIG. 1, a uniform air flow intake with minimal turbulence helps to insure that the proper volume of air is input through the intake area within the limits of the desired air flow speed. Thus, because air is a fluid, and like all fluids, has inertial properties, air will present a resistive force to being started into motion as well as resisting any stopping force once it has gained momentum. Air, because of its molecular structure and laminar flow characteristics, will resist any change in direction and, if subjected to a direction change, will tend to expand or otherwise cause a reduction in the density of the air flow.

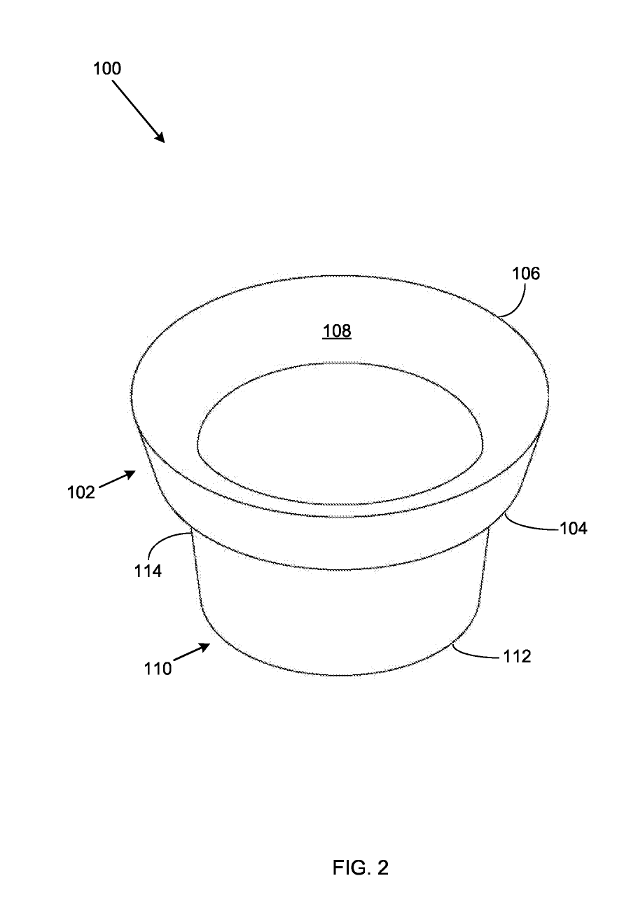

Looking now at FIG. 2, the velocity stack 100 is shaped and dimensioned to enable this uniform air flow at the intake, i.e., intake manifold, and attach to a variety of different manifolds. In one exemplary embodiment, the velocity stack 100 detachably connects to various types of throttle bodies. The velocity stack 100 may also be shaped and dimensioned to enable a laminar air flow through the throttle body, both at low velocities, and even at high velocities, where air turbulence ordinarily occurs. In this manner, fuel economy and engine performance may be enhanced as a smoother, larger density of air enters an intake manifold (not shown). Additionally, the universal velocity stack 100 can be used on multiple throttle bodies for different engines.

In some embodiments, the universal velocity stack 100 may form an improved throttle body air inlet (not shown) for maximizing the stability and quantity of the air delivered to the intake manifold. The universal velocity stack 100 is adapted to be coupled to the throttle body air inlet. The universal velocity stack 100 is configured to detachably connect with eclectic types and sizes of throttle body air inlets for both fuel injection, and carburetor types of throttle bodies. However, in some embodiments, the velocity stack 100 is generally designed for enhancing air flow in combustion engines, and specifically automobile engines having fuel injection systems.

Those skilled in the art will recognize that internal combustion engines develop horsepower directly proportional to air flow through a plurality of tubular air intake devices, or velocity stacks disposed in an air box portion of the engine, the air box portion being secured to and on top of a carburetor or throttle body which controls air flow into the cylinders of the engine. The present universal velocity stack 100 is interchangeable and effective for creating efficient airflow through an air intake by tempering high velocity and low velocity airflow to a more manageable uniform airflow.

As referenced in FIG. 2, the universal velocity stack 100 may form a substantially trumpet shape, having a cylindrical tube portion 110 that integrates into a gradually widening mouth portion 102. The tube portion 110 and the mouth portion 102 form unique surfaces and curvatures that enable formation of the laminar air flow. The mouth portion 102 is configured to receive air from an air filter (not shown), and the tube portion 110 is configured to detachably connect to the throttle body air intake for delivering the subsequently formed laminar air flow.

The unique curvatures and surface contours of the universal velocity stack 100 are efficacious for eliminating turbulence of air flow entering the throttle body air intake, and for increasing the density of air entering the intake manifold. Specifically, the mouth portion 102 forms a surface of revolution which is defined by a radius of curvature. The radius of curvature increases at a constant, linear rate, whereby air drawn into the mouth portion 102 is induced to flow in a substantially laminar manner. In this manner, the curvature of the mouth portion 102 and the surface contours of the tube portion 110 increase the air flow and enable the formation of a laminar flow, both at low velocities and at even at the high velocities where air turbulence ordinarily occurs. Thus, the intake air is amplified, and the subsequent laminar flow remains undisturbed.

Looking again at FIG. 2, the universal velocity stack 100 detachably connects to various types of throttle bodies, and is shaped and dimensioned to enable a laminar air flow through the throttle body, both at low velocities, and even at high velocities, where air turbulence ordinarily occurs. In this manner, fuel economy and engine performance may be enhanced as a smoother, larger density of air enters an intake manifold. Suitable materials of the universal velocity stack 100 may include, without limitation, metal alloys, aluminum, and steel.

The universal velocity stack 100 comprises a generally cylindrical tube portion 110 having a tube first end 112 and a tube second end 114. The tube first end 112 detachably connects with the throttle body air intake. The tube first end 112 may be sized to form a snug fit with the throttle body air intake, such that a seal is formed to restrict the escape of air flow. The tube first end 112 may have a circular shape. However, in other embodiments, the tube first end 112 is shaped to conform to an opening in the throttle body air inlet. Various fastening means may be used to secure the tube first end 112 to the throttle body air intake, including, without limitation, welding, screws, frictional engagement. Possible diameters for the tube first end 112 may be approximately between 30-40 millimeters. In one alternative embodiment, the diameter of the tube first end 112 may be adjusted to conform to different throttle body air inlets.

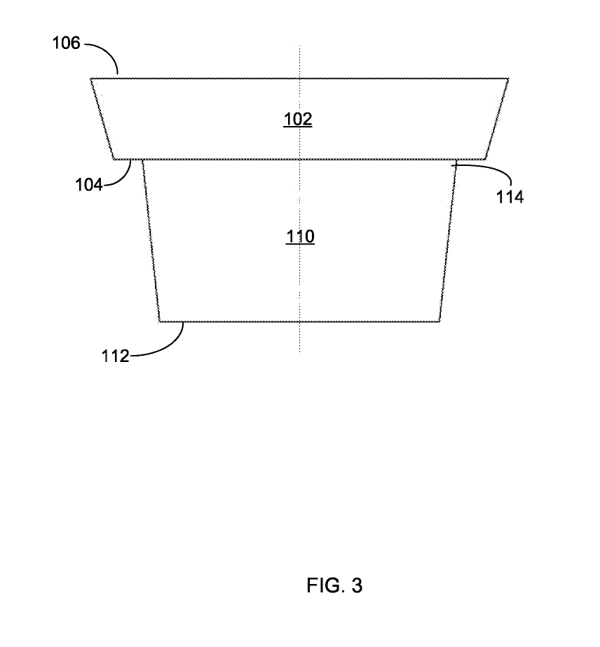

Turning now to FIG. 3, the tube portion 110 comprises a uniform, interior diameter 118 defined by an axis of symmetry 116. The interior diameter 118 is sufficiently smooth and uniform so as to enable the air to flow in parallel layers, with no disruption between the layers. Those skilled in the art will recognize that at low velocities, the air in the interior diameter 118 will generally flow without lateral mixing of air, and adjacent layers of air will slide past one another. At low velocities, there are no cross-currents perpendicular to the direction of flow, nor eddies, or swirls of air. However, at higher velocities, laminar flow is disturbed, and turbulent air can form. Thus the smooth, uniform interior diameter 118 of the tube portion 110 at least partially helps to maintain the laminar flow, even at high velocities.

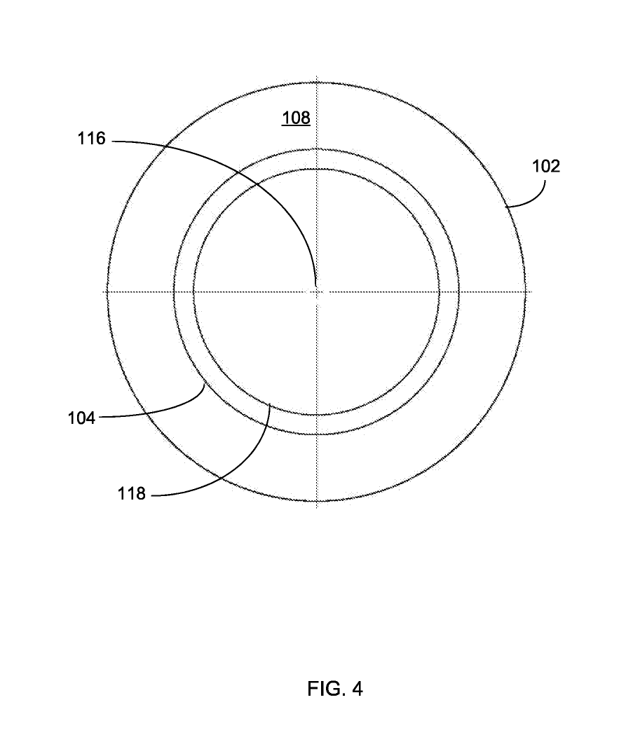

FIG. 4 shows the mouth portion 102 of the velocity stack 100 from a top view. The mouth portion 102 comprises a mouth first end 104 and a mouth second end 106. The mouth first end 104 is contiguous with the tube second end 114, forming a continuous volume for enabling the laminar air flow. The mouth second end 106 forms an opening through which the air enters the universal velocity stack 100. The mouth portion 102 may form a substantially bell shaped form, tapering from the mouth second end 106 to the mouth first end 104. However, in other embodiments, the diameter of the mouth first end 104 may be increased or decreased to achieve different performances for the engine.

The mouth portion 102 is defined by an interior surface 108 that is contiguous with the interior diameter 118 of the tube portion 110. The unique curvature of the bell-like mouth portion 102 provides the interior surface 108 which obviates any abrupt edges or directional changes and thereby permits the air to enter the universal velocity stack 100 without producing the turbulent eddy flow which would reduce the density of the air flow, the quantity of air delivered to the throttle body, or the air flow velocity.

The interior surface 108 of the mouth portion 102 forms a surface of revolution about the axis of symmetry 116 from the tube portion 110. The surface of revolution is defined by a radius of curvature. The radius of curvature is a measure of the radius of the mouth portion 102 which best approximates the curve at a point in the interior surface 108 commencing at the mouth second end 106. The radius of curvature increases at a constant, linear rate towards the mouth first end 104, whereby air drawn into the mouth second end 106 is induced to flow in a substantially laminar manner through the tube portion 110, and finally into the throttle body air inlet. In summation, the present invention is adaptable to be fit on a variety of throttle bodies, and also enhances air flow by enabling laminar air flow at high velocities.

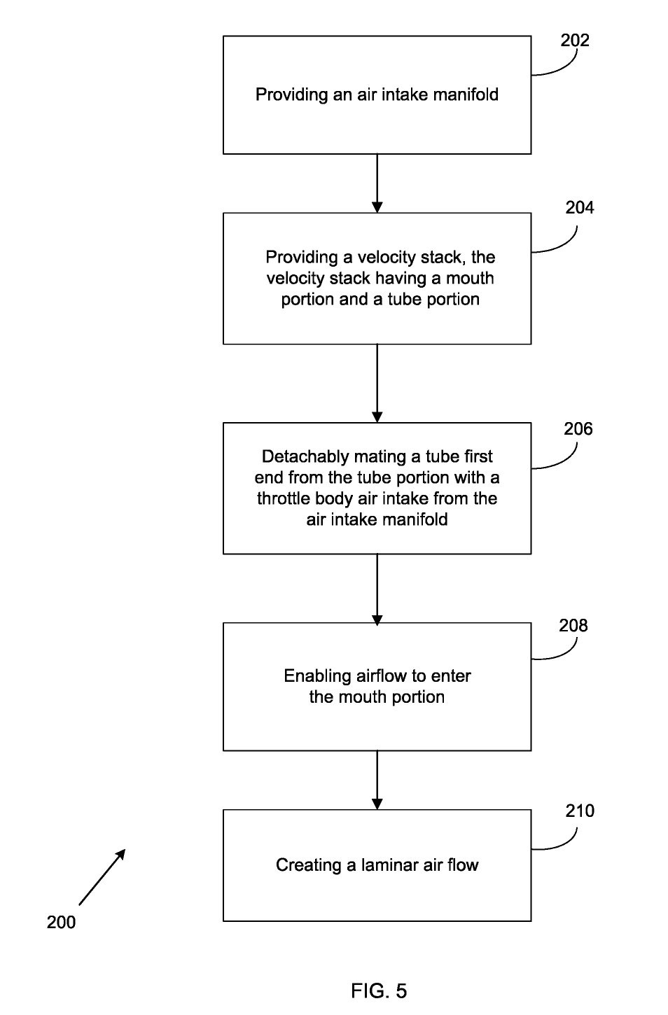

FIG. 5 illustrates a flowchart diagram of an exemplary method 200 for creating a laminar airflow through an intake manifold. The method 200 helps create efficient airflow through an air intake by tempering high velocity and low velocity airflow to a more manageable uniform airflow. The absence of turbulence creates the uniformity that is desirable for air intakes. The velocity stack 100 is adaptable to be used with myriad air intake systems including for a numerous combustion related devices, such as an intake manifold.

The method 200 may include an initial Step 202 of providing an air intake manifold. The universal velocity stack 100 may form an improved throttle body air inlet for maximizing the stability and quantity of the air delivered to the intake manifold. The universal velocity stack 100 is adapted to be coupled to the throttle body air inlet. The universal velocity stack 100 is configured to detachably connect with eclectic types and sizes of throttle body air inlets for both fuel injection, and carburetor types of throttle bodies.

The method 200 may further comprise a Step 204 of providing a velocity stack 100, the velocity stack 100 having a mouth portion 102 and a tube portion 110. The mouth portion 102 is defined by an interior surface 108 that is contiguous with the interior diameter 118 of the tube portion 110. The universal velocity stack 100 further comprises a generally cylindrical tube portion 110 having a tube first end 112 and a tube second end 114.

A Step 206 includes detachably mating a tube first end 112 from the tube portion 110 with a throttle body air intake from the air intake manifold. The tube first end 112 of the tube portion 110 detachably connects with the throttle body air intake. The tube first end 112 may be sized to form a snug fit with the throttle body air intake, such that a seal is formed to restrict the escape of air flow.

In some embodiments, a Step 208 comprises enabling airflow to enter the mouth portion 102. The unique curvature of the bell-like mouth portion 102 provides the interior surface 108 which obviates any abrupt edges or directional changes and thereby permits the air to enter the universal velocity stack 100 without producing the turbulent eddy flow which would reduce the density of the air flow, the quantity of air delivered to the throttle body, or the air flow velocity.

A final Step 210 includes creating a laminar air flow. The unique curvatures and surface contours of the universal velocity stack 100 are efficacious for eliminating turbulence of air flow entering the throttle body air intake, and for increasing the density of air entering the intake manifold. Specifically, the mouth portion 102 forms a surface of revolution which is defined by a radius of curvature. The radius of curvature increases at a constant, linear rate, whereby air drawn into the mouth portion 102 is induced to flow in a substantially laminar manner.

In this manner, the curvature of the mouth portion 102 and the surface contours of the tube portion 110 increase the air flow and enable the formation of a laminar flow, both at low velocities and at even at the high velocities where air turbulence ordinarily occurs. Thus, the intake air is amplified, and the subsequent laminar flow remains undisturbed.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A velocity stack for enabling laminar air flow at low and high velocities, the velocity stack comprising:
a generally cylindrical tube portion comprising a tube first end and a tube second end, the tube portion defined by a uniform, interior diameter defined by an axis of symmetry; and
a mouth portion comprising a mouth first end and a mouth second end, the mouth first end being contiguous with the tube second end, the mouth portion defined by an interior surface contiguous with the interior diameter of the tube portion, the interior surface of the mouth portion forming a surface of revolution about the axis of symmetry, the surface of revolution defined by a radius of curvature commencing at the mouth second end and increasing at a constant, linear rate towards the mouth first end, whereby air drawn into the mouth portion is induced to flow in a substantially laminar manner.

2. The velocity stack of claim 1, wherein the mouth portion forms a smooth surface.

3. The velocity stack of claim 1, wherein the mouth portion has a substantially bell shape.

4. The velocity stack of claim 1, wherein the tube portion has a substantially elongated, cylindrical shape.

5. The velocity stack of claim 1, wherein the tube first end is configured to detachably mate with a throttle body air intake.

6. The velocity stack of claim 5, wherein the detachable mating between the tube first end and the throttle body air intake is a frictional fit or a weld.

7. The velocity stack of claim 1, wherein the radius of curvature is a measure of the radius of the mouth portion which best approximates the curve at a point in the interior surface.

8. The velocity stack of claim 1, wherein the velocity stack is fabricated from a metal.

9. A method for creating a laminar airflow through an intake manifold, the method comprising:
providing an air intake manifold;
providing a velocity stack, the velocity stack having a mouth portion and a tube portion;
detachably mating a tube first end from the tube portion with a throttle body air intake from the air intake manifold;
enabling airflow to enter the mouth portion; and
creating a laminar air flow.

10. The method of claim 9, wherein the mouth portion forms a smooth surface.

11. The method of claim 9, wherein the mouth portion has a substantially bell shape.

12. The method of claim 9, wherein the tube portion has a substantially elongated, cylindrical shape.

13. The method of claim 9, wherein the detachable mating between the tube first end and the throttle body air intake is a frictional fit or a weld.

14. The method of claim 9, wherein the velocity stack is fabricated from a metal.
